(19) United States
(12) Patent Application Publication
(10) Pub. No.: US 2024/0347717 A1
(43) Pub. Date: Oct. 17, 2024

(54) CATHODE ACTIVE MATERIALS

(71) Applicant: Gelion Technologies Pty Ltd, North Sydney (AU)

(72) Inventors: Edward Bilbe, Reading (GB); Pilar Gomez Jimenez, Reading (GB); Yang Liu, Reading (GB); James Stevens, Reading (GB)

(21) Appl. No.: 18/639,535

(22) Filed: Apr. 18, 2024

Related U.S. Application Data
(63) Continuation of application No. PCT/GB2022/052694, filed on Oct. 21, 2022.

(30) Foreign Application Priority Data
Oct. 22, 2021 (GB) 2115191.5

(51) Int. Cl. H01M 4/505; C01G 45/12

(52) U.S. Cl. CPC H01M 4/505; C01G 45/1228; C01P 2002/52; C01P 2002/72; C01P 2002/76; C01P 2006/40

(57) ABSTRACT

The present invention relates to a lithium manganese metal oxide material which comprises a first crystalline phase having a cation-disordered rock salt structure and a second crystalline phase having an orthorhombic LiMnO₂ structure.

### FIELD OF THE INVENTION

The present invention relates to materials suitable for use as cathode active materials in secondary lithium-ion batteries, and to processes for their manufacture.

### BACKGROUND OF THE INVENTION

Lithium metal oxide materials having a layered structure are well-known for their utility as cathode materials in secondary lithium-ion batteries, in particular layered lithium metal oxides of the general composition LiMO₂, where M is a metallic species or a mixture of several such species.

For many years, cation disorder has been considered to be detrimental to Li₊ transport (and thus to the reversible capacity) of intercalation-type electrode materials. However, more recently work has shown that materials having a cation-disordered rock salt structure may also have utility in secondary lithium-ion batteries.

A cation-disordered rock salt material is a layered structure in which the cations are randomly arranged. Previous work in the area of cation-disordered rock salt materials has shown that these materials can provide suitable electrochemical performance—and in particular, can exhibit higher capacities than traditional layered lithium metal oxide cathode materials.

For example, WO2014055665A1 is a relatively early disclosure demonstrating the potential of cation-disordered rock salt materials. It discloses a discharge-positive (cathode) rock salt type electrode material for a lithium secondary battery with cation mixing.

There remains a need to provide such cathode materials with improved electrochemical performance, in particular with regards to discharge capacity and retention of discharge capacity over multiple charge and discharge cycles.

### SUMMARY OF THE INVENTION

The present inventors have surprisingly found that it is possible to synthesise lithium manganese metal oxide materials having a cation-disordered rock salt crystalline phase and at least one additional orthorhombic crystalline phase, and that such materials provide improved electrochemical performance.

Therefore, in a first aspect of the invention there is provided a lithium manganese metal oxide material which comprises a first crystalline phase with a cation-disordered rock salt structure and a second crystalline phase with an orthorhombic LiMnO₂ structure. The presence of the first and second crystalline phases may be determined by x-ray diffraction analysis.

In a second aspect of the invention there is provided a process for the production of a lithium manganese metal oxide material according to the first aspect, the process comprising the steps of:
(i) milling a lithium-containing compound, a manganese-containing compound, at least one M-containing compound and optionally a fluorine-containing compound to form a milled precursor mixture;
(ii) heat treatment of the milled precursor mixture using a temperature profile in which the milled precursor mixture is heated to a temperature in the range of and including 900° C. to 1100° C.

In a third aspect of the invention there is provided an electrode comprising a lithium manganese metal oxide material according to the first aspect, or an electrode comprising a lithium manganese metal oxide material obtained or obtainable by a process according to the second aspect.

In a fourth aspect of the invention there is provided an electrochemical cell comprising an electrode according to the third aspect.

### BRIEF DESCRIPTION OF THE DRAWINGS

FIG. 1 shows an extract from a peak fitted x-ray diffraction pattern in the 2θ range 41-47° for Example 11.

FIG. 2 shows a plot of % orthorhombic LiMnO2 crystalline phase vs electrochemical characteristics for the materials produced in Examples 1 to 13.

### DETAILED DESCRIPTION

Preferred and/or optional features of the invention will now be set out. Any aspect of the invention may be combined with any other aspect of the invention unless the context demands otherwise. Any of the preferred and/or optional features of any aspect may be combined, either singly or in combination, with any aspect of the invention unless the context demands otherwise.

The present invention relates to lithium manganese metal oxide materials which comprise a first crystalline phase with a cation-disordered rock salt structure and a second crystalline phase with an orthorhombic LiMnO2 structure. The presence of such crystalline phases may be determined by x-ray diffraction analysis with reference to databases of powder x-ray diffraction files, such as the PDF-4+ database. Such materials are suitable for use as cathode active materials in secondary lithium-ion batteries.

The materials have a first crystalline phase with a cation-disordered rock salt structure. Preferably, the first crystalline phase is formed from a lithium manganese metal oxide material. The term “cation-disordered rock salt structure” is used herein to describe a structure having a cubic close-packed crystal lattice in which oxide anions are arranged in a cubic close-packed lattice, cations occupy the octahedral sites in the lattice, and wherein there is a disordered arrangement of cations on the cation lattice. A cation-disordered rock salt structure material typically has a symmetry belonging to the space group Fm-3m.

The lithium manganese metal oxide materials have a second crystalline phase with an orthorhombic LiMnO₂ structure. Orthorhombic LiMnO₂ (o-LiMnO₂) has a symmetry belonging to the Pmnm space group.

Typically, the integrated peak area for the second crystalline phase is at least 2% of the total integrated peak areas in the x-ray diffraction pattern of the lithium manganese metal oxide material. The amount of the orthorhombic LiMnO₂ phase may be determined by carrying out phase identification of x-ray diffraction pattern and integrating the peaks corresponding to orthorhombic LiMnO₂. The percentage of the total integrated peak area may then be determined by measuring the total peak area of all peaks in the x-ray diffraction pattern (including those corresponding to orthorhombic LiMnO₂) and calculating a percentage value for the second crystalline phase. It is preferred to carry out such peak area analysis on peaks in the 2θ range 41-47°. It may be further preferred to obtain the percentage of the second crystalline phase by calculating:

(Peak Area 45°/Peak Area 41-47°)*100

in which Peak Area 45° is the peak area of a peak at a 2θ value of 45° corresponding to orthorhombic LiMnO₂, and Peak Area 41-47° is the total area of all of the peaks in the 2θ range 41-47°.

It may be preferred that the integrated peak area for the second crystalline phase is at least 3% of the total integrated peak areas, at least 4%, at least 5%, or at least 10%. It may be preferred that the integrated peak area for the second crystalline phase is less than or equal to 30% of the total integrated peak areas, or less than or equal to 25% of the total integrated peak areas. It may be preferred that the integrated peak area for the second crystalline phase is in the range of and including 2% to 30% of the total integrated peak areas, such as in the range of and including 3% to 25% of the total integrated peak areas. It has been found that the presence of the second crystalline phase provides materials with an enhanced discharge capacity and an improvement in retention of discharge capacity over multiple charge and discharge cycles.

Typically, the integrated peak area for the first crystalline phase is in the range of and including 10% to 98% of the total integrated peak areas. It may be preferred that the integrated peak area for the first crystalline phase is in the range of and including 20% to 98% of the total integrated peak areas, such as in the range of and including 30% and 98% of the total integrated peak areas, or in the range of and including 30% and 90% of the total integrated peak areas, or in the range of and including 50% and 98%, 50% and 90%, or 50% and 80% of the total integrated peak areas.

The lithium manganese metal oxide material may contain one or more additional crystalline phases. The one or more additional phases may have an orthorhombic or a cubic structure. Typically, such phases may be present with an integrated peak area in the range of and including 0% to 60% of the total integrated peak areas, such as in the range of and including 0% to 25% of the total integrated peak areas. For instance, such phases may be present with an integrated peak area in the range of from greater than 0% to 60% of the total integrated peak areas, such as in the range of and including 1% to 60% of the total integrated peak areas, or even in the range of from greater than 0% to 25% of the total integrated peak areas, such as in the range of and including 1% to 25% of the total integrated peak areas. If the one or more additional phases has an orthorhombic structure, then such phases may be formed, for example by doping of the orthorhombic LiMnO₂ structure with one or more metals M. For example, in the case where M is Nb, an additional phase may be observed which it is believed corresponds to niobium-doped LiMnO₂. Alternatively, the one or more additional crystalline phases may comprise Li₃NbO₄. The Li₃NbO₄ is typically cubic. If the lithium manganese metal oxide material consists of three crystalline phases, then the three crystalline phases may be a cation-disordered rock salt structure, an orthorhombic LiMnO₂ structure and a cubic Li₃NbO₄ structure, for example. It will be understood by the skilled person that the lithium manganese metal oxide material may comprise amorphous material which does not contribute to the total integrated peak area measured by x-ray diffraction analysis.

It may be preferred that the lithium manganese metal oxide material comprises a first crystalline phase with a cation-disordered rock salt structure with an integrated peak area in the range of and including 10% to 98% of the total integrated peak areas, a second crystalline phase with an orthorhombic LiMnO₂ structure with an integrated peak area in the range of and including 2% to 30% of the total integrated peak areas. The lithium manganese metal oxide material may comprise one or more additional crystalline phases (which may preferably have an orthorhombic or a cubic structure) which make up the balance of the total integrated peak area (i.e. the remaining % of the integrated peak area). The one or more additional crystalline phases are typically present in the range of and including 0% (for example greater than 0%, such as from and including 1%) to 60% of the total integrated peak areas, such as in the range of and including 0% (for example greater than 0%, such as from and including 1%) to 25% of the total integrated peak areas. The additional crystalline phase may correspond to M-doped LiMnO₂.

Preferably, the lithium manganese metal oxide materials have a composition according to Formula 1:

Li₁₊ₓM_{y}Mn_{1-x-y}O_{2-z}F_{z} Formula 1

in which:

$$\begin{matrix}\\ \\ \begin{matrix}0 < x \leq 0.5 \\ 0 < y \leq 0.5 \\ 0 \leq z < 0.3\end{matrix}\end{matrix}$$

M is one or more of Ni, Co, Cr, Fe, Nb, Ti, Mo, V, Zr, Mg, Al, and Zn.

It will be understood by the skilled person that the composition according to Formula 1 is the overall composition of the lithium manganese metal oxide material including each crystalline phase present. Such composition may be measured, for example by inductively coupled plasma mass spectrometry (ICP-MS).

Preferably, x≠0.5, or y≠0.5. In other words, preferably either 0<x<0.5 or 0<y<0.5.

In Formula 1, 0<x≤0.5. It may be preferred that 0<x≤0.45, 0<x≤0.40, 0<x≤0.35, 0<x≤0.30, 0.05≤x≤0.30, 0.10≤x≤0.30, 0.15≤x≤0.30, or 0.20≤x≤0.30.

In Formula 1, 0<y≤0.5. It may be preferred that 0<y≤0.45, 0<y≤0.40, 0<y≤0.35, 0<y≤0.30, 0.05≤y≤0.30, 0.10≤y≤0.30, 0.15≤y≤0.30, or 0.20≤y≤0.30.

In Formula 1, 0≤z<0.3. It may be preferred that 0≤z<0.25, 0≤z<0.20, 0≤z<0.15, 0≤z<0.10, 0≤z<0.05, or that z=0. In some embodiments, z>0, or z≥0.05, in combination with any of these ranges.

In Formula 1, M is one or more of Ni, Co, Cr, Fe, Nb, Ti, Mo, V, Zr, Mg, Al, and Zn. It may be preferred that M is one or more of Nb and Ti, optionally in combination with one or more of Ni, Co, Cr, Fe, Mo, V, Zr, Mg, Al, and Zn. It may be further preferred that M is Nb, optionally in combination with one or more of Ni, Co, Cr, Fe, Ti, Mo, V, Zr, Mg, Al, and Zn.

It may be preferred that 0<x≤0.3, 0<y≤0.3, 0≤z<0.3, and M is one or more of Ni, Co, Cr, Fe, Nb, Ti, Mo, V, Zr, Mg, Al, and Zn. It may be further preferred that 0.1≤x≤0.3, 0.1≤y≤0.3, z=0, and M is one or more of Ni, Co, Cr, Fe, Nb, Ti, Mo, V, Zr, Mg, Al, and Zn. It may be further preferred that 0.1≤x≤0.3, 0.1≤y≤0.3, z=0, and M is one or more of Nb and Ti, optionally in combination with one or more of Ni, Co, Cr, Fe, Mo, V, Zr, Mg, Al, and Zn.

Typically, the lithium manganese metal oxide material is a polycrystalline material, meaning that each particle of lithium manganese metal oxide material is made up of multiple crystal grains (also known as primary particles) which are agglomerated together. The crystal grains are typically separated by grain boundaries. Where the particulate lithium nickel composite oxide is polycrystalline, it will be understood that the particles of lithium manganese metal oxide material comprising multiple crystal grains are secondary particles.

The lithium manganese metal oxide material typically has a D50 particle size of at least 1 μm, e.g. at least 2 μm, at least 3 μm, at least 4 μm, at least 5 μm, at least 5.5 μm, at least 6.0 μm or at least 6.5 μm. The particles of lithium manganese metal oxide material typically have a D50 particle size of 20 μm or less, e.g. 15 μm or less or 12 μm or less. In some embodiments, the D50 particle size is from about 1 μm to about 20 μm, for example about 3 μm to about 20 μm. Unless otherwise specified herein, the term D50 as used herein refers to the median particle diameter of the volume-weighted distribution. The D50 may be determined by using a laser diffraction method. For example, the D50 may be determined by suspending the particles in water and analysing using a Malvern Mastersizer 3000.

The lithium manganese metal oxide materials as described herein may be produced by a process comprising a step of (i) milling a lithium-containing compound, a manganese-containing compound, at least one M-containing compound and optionally a fluorine-containing compound to form a milled precursor.

Typically, the milling in step (i) involves high energy milling. The term “high energy milling” is a term well understood by those skilled in the art, to distinguish from milling or grinding treatments where lower amounts of energy are delivered. For example, high energy milling may be understood to relate to milling treatments in which at least 0.1 kWh of energy is delivered during the milling treatment, per kilogram of solids being milled. For example, at least 0.15 kWh, or at least 0.20 kWh may be delivered per kilogram of solid being milled. There is no particular upper limit on the energy, but it may be less than 1.0 kWh, less than 0.90 kWh, or less than 0.80 kWh per kilogram of solids being milled. Energy in the range from 0.20 kWh/kg to 0.50 kWh/kg may be typical. The milling energy is typically sufficient to cause mechanochemical reaction of the solids being milled

The milling step may be carried out using a range of milling techniques that are well known to the skilled person. Suitably the milling may be carried out in a planetary mill, a vibration mill, an attritor mill, a pin mill, or a rolling mill. Suitably, the milling step is a dry milling step, i.e. no solvents are added to the mixture that is subjected to milling.

Typically, the milling step is carried out for a period of at least 15 minutes, at least 30 minutes, at least 45 minutes, or at least 60 minutes. It will be understood by the skilled person that the period is the total length of time of milling of the starting compounds, which may be the sum of two or more periods of milling. Typically, the milling is carried out for a period of less than 8 hours, preferably less than 6 hours, or less than 4 hours. Typically, the milling is carried out for a period of between 15 minutes and 8 hours. Preferably, the milling is carried out for a period of between 30 minutes and 4 hours. This milling time provides a suitable balance between sufficient mechanochemical reaction of the starting compounds and process efficiency.

In one preferred method, the mixing is performed by planetary milling at 200 rpm for 15 mins×4, for a total milling time of 1 hour.

It may be preferred that the milling step is carried out in a CO₂-free atmosphere, such as in argon, nitrogen, or a mixture of nitrogen and oxygen. As used herein, the term “CO₂-free” is intended to include atmospheres including less than 100 ppm CO₂, e.g. less than 50 ppm CO₂, less than 20 ppm CO₂ or less than 10 ppm CO₂. These CO₂ levels may be achieved by using a CO₂ scrubber to remove CO₂. The use of CO₂-free air during the milling step offers the reduction in the level of lithium carbonate in the formed lithium manganese metal oxide materials.

Typically, the milling step is carried out using grinding media, such as milling balls. Preferably, such media are selected to avoid metal contamination of the lithium manganese metal oxide materials formed. Preferably the milling media is formed from, or coated with, alumina or yttria-stabilised zirconia.

Typically, the lithium-containing compound comprises lithium ions and a suitable inorganic or organic counter-ion. Suitable lithium-containing compounds include lithium salts, such as inorganic lithium salts. Preferably the lithium-containing compound is lithium carbonate or lithium hydroxide.

Typically, the lithium-containing compound is mixed with the manganese-containing compound and the M-containing compound(s) prior to the milling step. Alternatively, or in addition, the lithium-containing compound may be added part of the way through the milling process step.

Typically, the manganese-containing compound comprises manganese ions and a suitable inorganic or organic counter-ion. Suitable manganese-containing compounds include manganese oxides and manganese salts, such as inorganic manganese oxides and manganese salts, and in particular inorganic manganese (III) oxides and manganese (III) salts. Preferably the manganese-containing compound is manganese (III) oxide.

Typically, the one or more M-containing compounds are metal oxides or salts, such as inorganic metal oxides or metal salts. Preferably the M-containing compounds are M-containing oxides, M-containing hydroxides, and M-containing oxalates. In cases in which M is Nb, it may be preferred that the M-containing compound is niobium oxide (Nb₂O₅).

Typically, the optional fluorine-containing compound comprises fluorine ions and a suitable inorganic or organic counter-ion. Suitable fluorine-containing compounds include fluorine salts, such as inorganic fluorine salts. Preferably the fluorine-containing compound is lithium fluoride.

The process comprises a step (ii) heat treatment of the milled precursor mixture using a temperature profile in which the milled precursor mixture is heated to a temperature in the range of and including 900° C. to 1100° C.

The heat treatment step may include heating to a temperature greater than 925° C., 950° C., 975° C., or 1000° C. The heat treatment step may be carried out at a temperature of 1100° C. or less, 1075° C. or less, 1050° C. or less, or 1025° C. or less. It may be preferred that the heat treatment step includes heating to a temperature in the range of and including about 900 to about 1050° C., or about 925 to about 1025° C.

The precursor mixture may be heat treated for a period of between 1 hour and 24 hours. For example, the heat treatment may be performed for a period of at least 1 hour, at least 2 hours, at least 4 hours, at least 6 hours, or at least 10 hours. Heat treatment may be performed for a period of no more than 24 hours, no more than 20 hours, no more than 18 hours, no more than 15 hours, or no more than 12 hours. It may be preferred that the heat treatment step includes heating to a temperature in the range of and including about 900° C. to about 1100° C. for a period in the range of and including 1 to 24 hours, or heating to a temperature in the range of and including about 925° C. to about 1025° C. for a period in the range of and including 1 to 20 hours.

Suitably, the milled precursor is not heated to a temperature greater than 1025° C. for a period longer than 8 hours. Limitation of the time that the precursor mixture is heated to a temperature above 1025° C. can be used to provide lithium manganese metal oxide materials with the desired crystalline phases. It may be preferred that the time that the precursor mixture is heated to a temperature above 1025° C. is less than 6 hours, less than 5 hours, less than 4 hours, or less than 3 hours, such as between 0 and 3 hours.

The heat treatment step (ii) may include a first heat treatment phase in which the milled precursor mixture is held at a temperature in the range of and including 600 to 800° C. and a second heat treatment phase in which the milled precursor mixture is heated to a temperature in the range of and including 900° C. to 1100° C.

The first heat treatment phase may be performed at a temperature of between 600 to 800° C., 625 to 775° C., 650 to 750° C., 675 to 725° C. or about 700° C. The first heat treatment phase may be performed for a period in the range of and including one and eight hours, such as a period in the range of and including one and five hours.

The heat treatment may be carried out in any suitable furnace known to the person skilled in the art, for example a static kiln (such as a tube furnace or a muffle furnace), a tunnel furnace (in which static beds of material are moved through the furnace, such as a roller hearth kiln or push-through furnace), or a rotary furnace (including a screw-fed or auger-fed rotary furnace). The furnace used for heat treatment is typically capable of being operated under a controlled gas atmosphere.

The process may include one or more milling steps which are carried out after the heat treatment steps. The nature of the milling equipment is not particularly limited. For example, it may be a ball mill, a planetary ball mill or a rolling bed mill. Alternatively, the materials may be manually ground, e.g. using a pestle and mortar, and/or sieved. The milling may be carried out until the particles (e.g. secondary particles) reach the desired size. For example, the particles of lithium manganese metal oxide material are typically milled until they have a D50 particle size of 20 μm or less, e.g. 15 μm or less, for example a D50 particle size in the range of 1 to 20 μm, or of 2 to 15 μm.

The process of the present invention may further comprise the step of forming an electrode (typically a cathode) comprising the lithium manganese metal oxide material. Typically, this is carried out by forming a slurry of the particulate lithium manganese metal oxide material applying the slurry to the surface of a current collector (e.g. an aluminium current collector), and optionally processing (e.g. calendaring) to increase the density of the electrode. The slurry may comprise one or more of a solvent, a binder, carbon material and further additives.

Typically, the electrode of the present invention will have an electrode density of at least 2.5 g/cm³, at least 2.8 g/cm³ or at least 3 g/cm³. It may have an electrode density of 4.5 g/cm³ or less, or 4 g/cm³ or less. The electrode density is the electrode density (mass/volume) of the electrode, not including the current collector the electrode is formed on. It therefore includes contributions from the active material, any additives, any additional carbon material, and any remaining binder.

The process of the present invention may further comprise constructing a battery or electrochemical cell including the electrode comprising the lithium manganese metal oxide material. The battery or cell typically further comprises an anode and an electrolyte. The battery or cell may typically be a secondary (rechargeable) lithium (e.g. lithium ion) battery.

The present invention will now be described with reference to the following examples, which are provided to assist with understanding the present invention and are not intended to limit its scope.

### EXAMPLES

The present invention will now be described with reference to the following examples, which are provided to assist with understanding the present invention and are not intended to limit its scope.

### Preparation of Li_{1.25}Nb_{0.25}Mn_{0.5}O₂ Materials

A mixture of Li₂CO₃ (18.66 g), Mn₂O₃ (13.30 g), and Nb₂O₅ (15.95 g) were milled using a planetary ball mill. The precursors were milled in a 250 mL yttrium-stabilised zirconia (YSZ) milling pot with 50 g of 10 mm YSZ milling media at 200 rpm (4×15 minutes). Portions of the milled precursor mixture were heated treated under a flow of argon with a first hold at 700° C. and a second hold at a temperature between 950 and 1050° C. under various conditions using a Design of Experiments plan as set out in Table 1. After heat treatment the samples were ground and sieved using a 63 μm sieve.

TABLE 1
Variation in heat treatment conditions

| | | Duration of | | Temp of | Duration of | |
|---|---|---|---|---|---|---|
| Ex. | Ar flow | first hold at | Ramp up | second | second hold | Ramp down |
| ID | (L/min) | 700° C. (hrs) | (° C./min) | hold (° C.) | (hrs) | (° C./min) |
| 1 | 0.5 | 0 | 2 | 1050 | 12 | 8 |
| 2 | 0.5 | 4 | 2 | 950 | 22 | 5 |
| 3 | 1.5 | 0 | 8 | 1050 | 2 | 5 |
| 4 | 0.5 | 4 | 5 | 1050 | 2 | 2 |
| 5 | 0.5 | 0 | 8 | 1000 | 22 | 2 |
| 6 | 1.5 | 4 | 8 | 950 | 12 | 2 |
| 7 | 0.5 | 2 | 8 | 950 | 2 | 8 |
| 8 | 1 | 4 | 8 | 1050 | 22 | 8 |
| 9 | 1.5 | 4 | 2 | 1000 | 2 | 8 |
| 10 | 1.5 | 0 | 5 | 950 | 22 | 8 |
| 11 | 1 | 0 | 2 | 950 | 2 | 2 |
| 12 | 1.5 | 2 | 2 | 1050 | 22 | 2 |
| 13 | 1 | 2 | 5 | 1000 | 12 | 5 |

The formed materials were analysed by x-ray diffraction and tested for electrochemical properties.

### Analysis by X-Ray Diffraction (XRD)

Examples 1 to 13 were analysed by ambient x-ray diffraction using a Bruker AXS D8 with Cu Kαradiation (y=1.5406+1.54439 Å. Phase identification was carried out using Bruker AXS Diffrac Eva V5 (2010-2018) software with reference to the PDF-4₊ database (release 2020). Non-structural models were used to fit the observed scattering in the 20 range between 41-47°. The integrated areas for (i) a LiMnO₂ phase; and (ii) a cation-disordered rock salt structure phase were measured in the specified 2θ range and a percentage of the total area from all phases calculated. The results are shown in Table 2. This data shows that Examples 1, 8 and 12 (produced using an extended hold at 1050° C.) are a single cation-disordered rock salt phase by XRD and are therefore Comparative Examples. The highest proportion of orthorhombic LiMnO₂ phase is observed in Examples 6, 7, and 11.

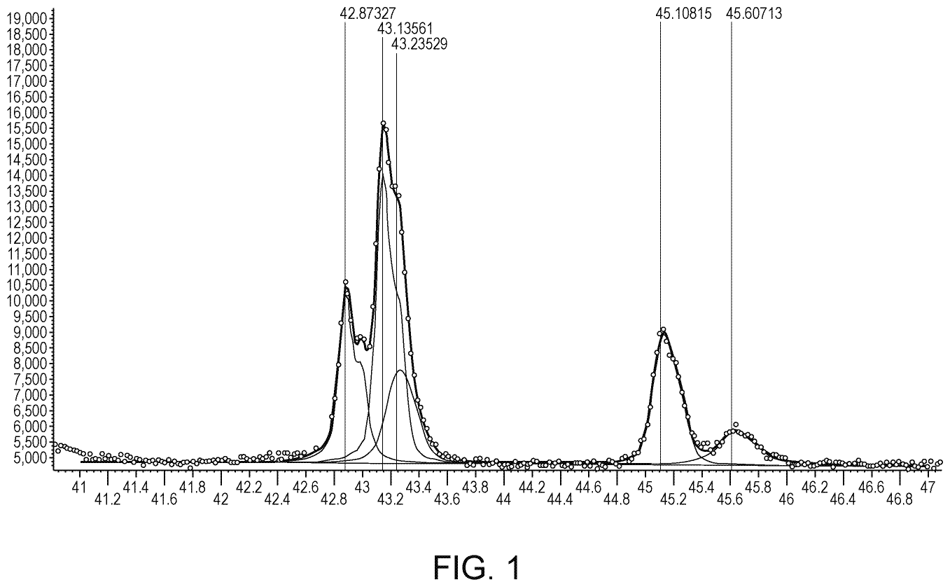

An extract from a peak fitted x-ray diffraction pattern in the 2θ range 41-47° for Example 11 is shown in FIG. 1. The peak at 45.1 corresponds to orthorhombic LiMnO₂. The peak at 43.3 corresponds to a cation-disordered rock salt structure. The other peaks are considered to correspond to a niobium-doped orthorhombic lithium manganese oxide material.

### Electrochemical Testing

Cathodes were prepared using the materials produced in Examples 1 to 13 by mixing the active material with PVDF binder and C65 with a weight ratio of 80:10:10 using a Thinky mixer. The electrochemical properties of the samples were then characterised using a half-cell against Li metal with various charge/discharge rates between 1.5-4.8 V at 23° C.

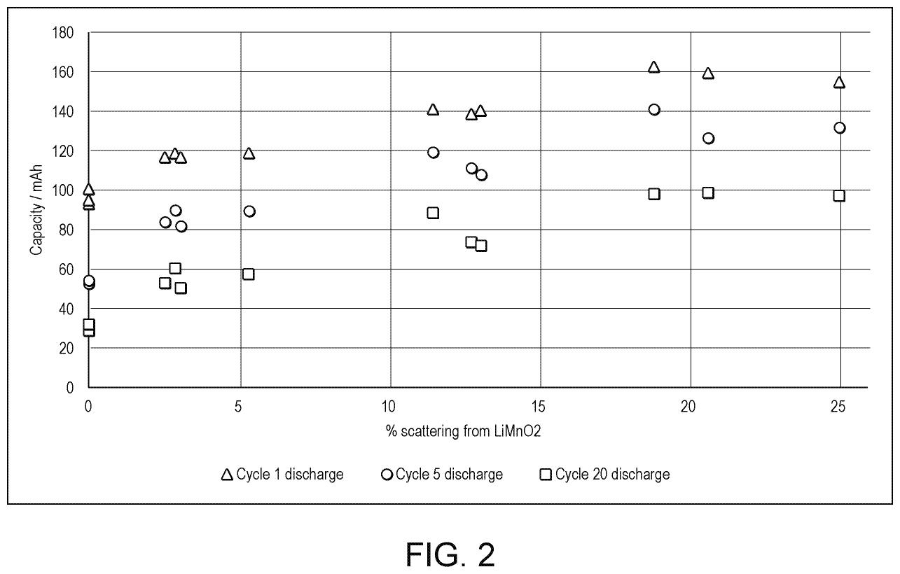

LP30 was used as electrolyte. The discharge capacity results for cycle 1 (C/50), cycle 5 (C/20) and cycle 20 (C/10) are provided in Table 2 and the discharge capacities vs the % LiMnO₂ phase by XRD plotted in FIG. 2. The % retention of discharge capacity from cycle 1 (C/50) to cycle 20 (C/10) was calculated. This value provides an indication of performance retention over repeated charge-discharge cycles and of rate performance.

The data indicates that the discharge capacity across a range of discharge rates is increased with the inclusion of an orthorhombic LiMnO₂ phase in comparison with phase pure cation disordered rock salt materials.

TABLE 2
The results of XRD analysis and electrochemical testing of the lithium
manganese metal oxide materials produced according to Examples 1 to 13.

| | % cation- | | | Cycle 1 | Cycle 5 | Cycle 20 | Discharge |
|---|---|---|---|---|---|---|---|
| | disordered | % | | discharge | discharge | discharge | capacity |
| | rock salt | LiMnO₂ | Other | capacity | capacity | capacity | retention |
| Ex. | phase | phase | phases | mAh/g | mAh/g | mAh/g | (%) |
| 1 | 100 | 0 | 0 | 100 | 55 | 32 | 32 |
| 2 | 63 | 13 | 24 | 139 | 111 | 74 | 53 |
| 3 | 72 | 3 | 25 | 117 | 82 | 50 | 43 |
| 4 | 74 | 3 | 23 | 117 | 84 | 53 | 45 |
| 5 | 82 | 3 | 15 | 119 | 90 | 60 | 50 |
| 6 | 74 | 19 | 8 | 163 | 141 | 98 | 60 |
| 7 | 59 | 21 | 20 | 159 | 127 | 99 | 62 |
| 8 | 100 | 0 | 0 | 95 | 53 | 29 | 31 |
| 9 | 34 | 11 | 55 | 141 | 119 | 88 | 62 |
| 10 | 48 | 13 | 39 | 140 | 108 | 72 | 51 |
| 11 | 16 | 25 | 59 | 155 | 132 | 97 | 63 |
| 12 | 100 | 0 | 0 | 93 | 54 | 30 | 32 |
| 13 | 41 | 5 | 54 | 119 | 90 | 57 | 48 |

1. A lithium manganese metal oxide material which comprises a first crystalline phase having a cation-disordered rock salt structure and a second crystalline phase having an orthorhombic LiMnO₂ structure.

2. A lithium manganese metal oxide material according to claim 1 wherein the integrated peak area for the second phase is at least 2% of the total integrated peak areas in the x-ray diffraction pattern.

3. A lithium manganese metal oxide material according to claim 1 wherein the integrated peak area for the second phase is in the range of and including 2 to 30% of the total integrated peak areas, such as in the range of and including 3 to 25% of the total integrated peak areas.

4. A lithium manganese metal oxide material according to claim 1 in which the first crystalline phase has a symmetry belonging to the space group Fm-3m.

5. A lithium manganese metal oxide material according to claim 1 in which the second crystalline phase has a symmetry belonging to the space group Pmnm.

6. A lithium manganese metal oxide material according to claim 1 in which the integrated peak area for the first phase is the range of and including 10 to 98% of the total integrated peak areas, such as in the range of and including 30 and 98% of the total integrated peak areas, or in the range of and including 50 and 98% of the total integrated peak areas.

7. A lithium manganese metal oxide material according to claim 1 comprising at least one additional crystalline phase, preferably wherein the at least one additional crystalline phase has an orthorhombic or a cubic structure.

8. A lithium manganese metal oxide material according to claim 1 with a composition according to Formula 1:
Li1+xMyMn1−x−yO2−zFz Formula 1
in which:
$$\begin{matrix}\\ \\ \begin{matrix}0 < x \leq 0.5 \\ 0 < y \leq 0.5 \\ 0 \leq z < 0.3\end{matrix}\end{matrix}$$
M is one or more of Ni, Co, Cr, Fe, Nb, Ti, Mo, V, Zr, Mg, Al, and Zn.

9. A lithium manganese metal oxide material according to claim 8, wherein M is Nb and/or Ti, optionally in combination with one or more of Ni, Co, Cr, Fe, Ti, Mo, V, Zr Mg, Al, and Zn.

10. A lithium manganese metal oxide material according to claim 8, wherein 0.1≤x≤0.3, 0.1<y<0.3, and 0≤z<0.3.

11. A process for the production of a lithium manganese metal oxide material according to claim 1, the process comprising the steps of:
(i) milling a lithium-containing compound, a manganese-containing compound, at least one M-containing compound and optionally a F-containing compound, to form a milled precursor mixture;
(ii) heat treatment of the milled precursor mixture using a temperature profile in which the milled precursor mixture is heated to a temperature in the range of and including 900° C. to 1100° C.

12. A process according to claim 11 wherein during step (ii) the milled precursor is not heated to a temperature greater than 1025° C. for a period longer than 8 hours.

13. A process according to claim 11 further comprising the step of forming an electrode comprising the lithium manganese metal oxide material.

14. A process according to claim 13 further comprising the step of constructing a battery or electrochemical cell including the electrode comprising the lithium manganese metal oxide material.

15. An electrode comprising a lithium manganese metal oxide material according to claim 1, or a lithium manganese metal oxide material obtained or obtainable by a process according to claim 11.

16. An electrochemical cell comprising an electrode according to claim 15.
